(19) United States
(12) Patent Application Publication
(10) Pub. No.: US 2012/0246407 A1
(43) Pub. Date: Sep. 27, 2012

(54) METHOD AND SYSTEM TO IMPROVE UNALIGNED CACHE MEMORY ACCESSES

(76) Inventors: WILLIAM C. HASENPLAUGH, Cambridge, MA (US); Tryggve Fossum, Northborough, MA (US)

(21) Appl. No.: 13/052,468

(22) Filed: Mar. 21, 2011

(51) Int. Cl. G06F 12/08

(52) U.S. Cl. 711/122; 711/128; 711/E12.024; 711/E12.018

(57) ABSTRACT

A method and system to improve unaligned cache memory accesses. In one embodiment of the invention, a processing unit has logic to facilitate access of at least two cache memory lines of a cache memory in a single read operation. By doing so, it avoids additional read operations or cycles to read the required data that is cached in more than one cache memory line. Embodiments of the invention facilitate the streaming of unaligned vector loads that does not require substantially more power than streaming aligned vector loads. For example, in one embodiment of the invention, the streaming of unaligned vector loads consumes less than two times the power requirements of streaming aligned vector loads.

### FIELD OF THE INVENTION

This invention relates to a cache device, and more specifically but not exclusively, to a method and system to improve unaligned cache memory accesses.

### BACKGROUND DESCRIPTION

A processor may use vector loading to improve the bandwidth of data processing. This allows a single instruction to operate on multiple pieces of data in parallel.

However, when the data to be accessed is cached in more than one cache memory line, two separate read accesses of the cache memory are required to obtain and combine the required data.

### BRIEF DESCRIPTION OF THE DRAWINGS

The features and advantages of embodiments of the invention will become apparent from the following detailed description of the subject matter in which:

FIG. 1 illustrates a block diagram of a processing unit in accordance with one embodiment of the invention;

FIG. 2 illustrates a block diagram of decoding logic in accordance with one embodiment of the invention;

FIG. 3 illustrates a format of a cache memory line address in accordance with one embodiment of the invention;

FIG. 4 illustrates an example of a cache memory line address in accordance with one embodiment of the invention; and

FIG. 5 illustrates a system to implement the methods disclosed herein in accordance with one embodiment of the invention.

### DETAILED DESCRIPTION

Embodiments of the invention described herein are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference numerals have been repeated among the figures to indicate corresponding or analogous elements. Reference in the specification to “one embodiment” or “an embodiment” of the invention means that a particular feature, structure, or characteristic described in connection with the embodiment is included in at least one embodiment of the invention. Thus, the appearances of the phrase “in one embodiment” in various places throughout the specification are not necessarily all referring to the same embodiment. The term “unaligned cache memory access” used herein means that the required data is cached in two or more cache memory lines of the cache memory in one embodiment of the invention.

Embodiments of the invention provide a method and system to improve unaligned cache memory accesses. In one embodiment of the invention, a processing unit has logic to facilitate access of at least two cache memory lines of a cache memory in a single read operation. By doing so, it avoids additional read operations or cycles to read the required data that is cached in more than one cache memory line. Embodiments of the invention facilitate the streaming of unaligned vector loads that does not require substantially more power than streaming aligned vector loads. For example, in one embodiment of the invention, the streaming of unaligned vector loads consumes less than two times the power requirements of streaming aligned vector loads.

In one embodiment of the invention, the cache memory is a level one (L1) cache memory. In another embodiment of the invention, the cache memory is a level two (L2) cache memory. One of ordinary skill in the relevant art will readily appreciate that the cache memory may also be of higher orders or levels without affecting the workings of the invention.

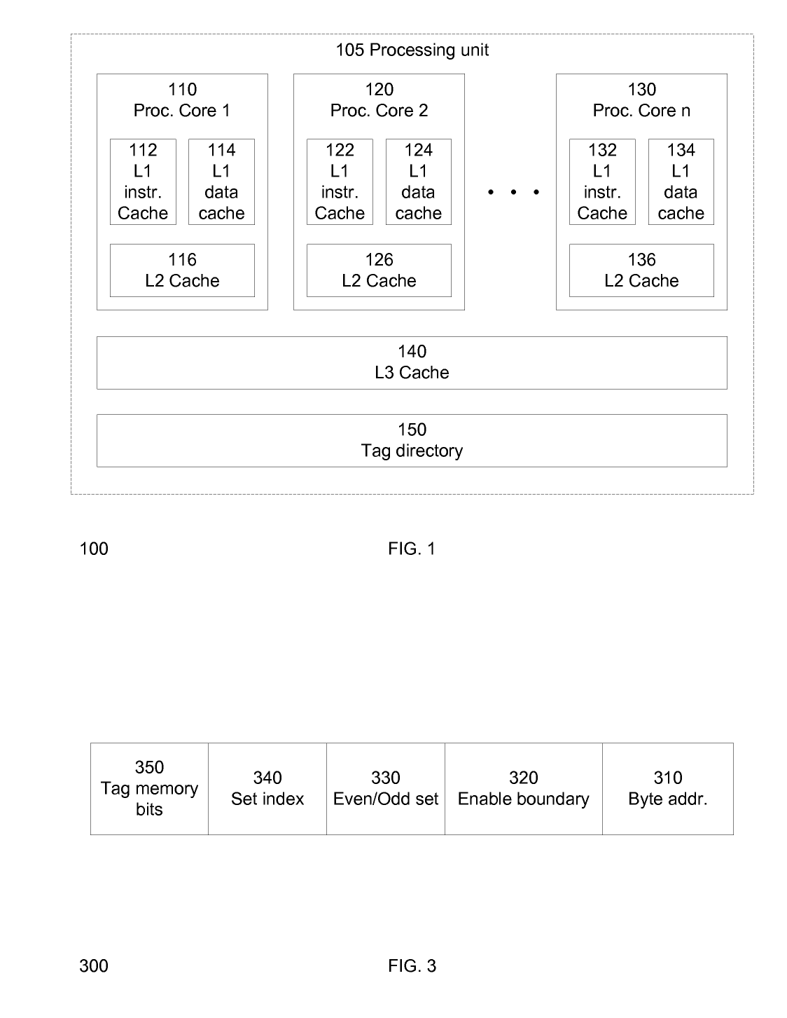

FIG. 1 illustrates a block diagram 100 of a processing unit 105 in accordance with one embodiment of the invention. The processing unit 105 has processing core 1 110 and processing core 2 120. The processing core n 130 illustrates that there can be more than two processing cores in one embodiment of the invention. In another embodiment of the invention, the processing unit 105 has only one processing core.

The processing core 1 110 has a L1 instruction cache memory 112, a L1 data cache memory 114, and a L2 cache memory 116. The processing core 2 120 and the processing core n 130 have a similar structure as the processing core 1 110 and shall not be described herein. In one embodiment of the invention, the processing unit 105 has a level three (L3)cache memory 140 that is shared among the processing cores 1 110, 2 120 and n 130. The processing unit 105 has a cache memory tag directory 150 that keeps track of all the cache memory lines in the cache memories of the processing cores.

In one embodiment of the invention, the processing unit 105 has logic to facilitate access of at least two cache memory lines of the L1 data cache memories 114, 124 and 134 in a single read operation. In another embodiment of the invention, the processing unit 105 has logic to facilitate access of at least two cache memory lines of the L2 cache memories 116, 126 and 136 in a single read operation. In yet another embodiment of the invention, the processing unit 105 has logic to facilitate access of at least two cache memory lines of the L3 cache memory 140 in a single read operation.

The processing unit 105 illustrated in FIG. 1 is not meant to be limiting. For example, in one embodiment of the invention, the processing unit 105 does not have the L3 cache memory 140. One of ordinary skill in the relevant art will readily see that other configurations of the processing unit 105 can be used without affecting the workings of the invention and these other configurations shall not be described herein.

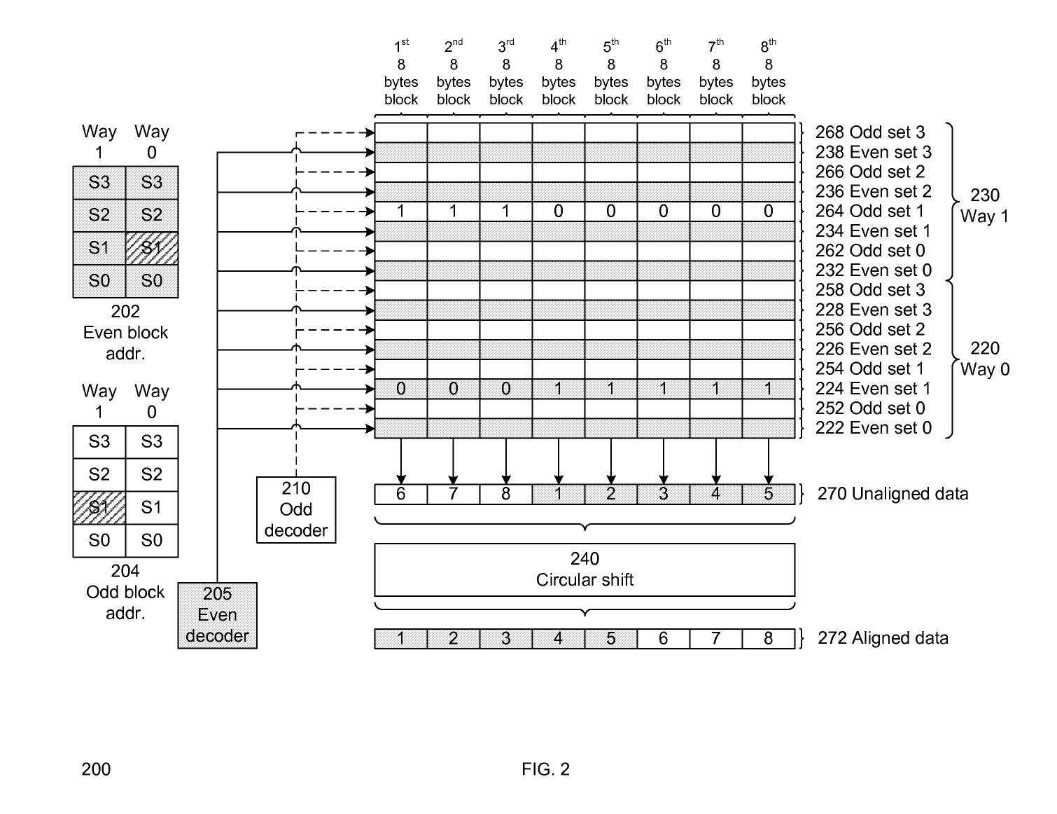

FIG. 2 illustrates a block diagram 200 of decoding logic in accordance with one embodiment of the invention. For clarity of illustration, FIG. 2 is discussed with reference to FIG. 1. For ease of illustration, the cache memory is assumed to have two cache ways (cache way 0 220 and cache way 1 230) and has 8 blocks of 8 bytes per cache memory line.

In one embodiment of the invention, the processing unit 105 separates the cache memory lines into a first set or group of cache memory lines and a second set or group of cache memory lines. Each of the cache memory lines in the first set of cache memory lines has an even cache memory line address and each of the cache memory lines in the second set of cache memory lines has an odd cache memory line address. In one embodiment of the invention, the cache memory line address is termed as byte address. In one embodiment of the invention, the Least Significant Bit (LSB) of the address of a particular cache memory line is used to determine whether the particular cache memory line is part of the first set of cache lines with an even cache line address or part of the second set of cache lines with an odd cache line address.

For example, in one embodiment of the invention, the cache memory has 8 cache memory lines that are designated as part of an even set, i.e, four cache memory lines of even set 0 222, even set 1 224, even set 2 226, even set 3 228 from cache way 0 220 and four cache memory lines of even set 0 232, even set 1 234, even set 2 236, even set 3 238 from cache way 1 230. The cache memory has 8 cache memory lines that are designated as part of an odd set, i.e, four cache memory lines of odd set 0 252, odd set 1 254, odd set 2 256, odd set 3 258 from cache way 0 220 and four cache memory lines of odd set 0 262, odd set 1 264, odd set 2 266, odd set 3 268 from cache way 1 230. Each of the cache memory lines in the even set has an even cache memory line address and each of the cache memory lines in the odd set has an odd cache memory line address.

The designation or classification of the cache memory lines into the even set and the odd set of cache memory lines facilitates a separate decoder for the even set and odd set of cache memory lines in one embodiment of the invention. The even decoder 205 is coupled to each of the cache memory lines in the even set and the odd decoder 210 is coupled to each of the cache memory lines in the odd set.

In one embodiment of the invention, the cache memory line address of the cache memory lines allows the even decoder 205 and the odd decoder 210 to decode which blocks of a cache memory line are selected for a read operation. For ease of illustration, the required data for a vector load is cached in the even set 1 224 and the odd set 1 264. The first 8 bytes block of the required data starts from the 4^{th} 8 bytes block of the even set 1 224 and the last byte of the required data is the 3^{rd} 8 bytes block of the odd set 1 264.

In one embodiment of the invention, the cache memory line address of the cache memory lines have enable signals to indicate which blocks of a cache memory line are selected for a read operation. For example, in FIG. 2, the even decoder 205 and the odd decoder 210 receive a cache memory line address that has enable signals that indicate that the b 4^{th}-8^{th} 8 bytes blocks of the even set 1 224 and the 1^{st}-3^{rd} 8 1 224 and the odd set 1 264, a value of 0 and 1 represented in each block indicates whether the block has been unselected or selected respectively in one embodiment of the invention.

The even decoder 205 receives and decodes the cache memory line address to select the 4^{th}-8^{th} 8 bytes blocks of the even set 1 224 as the 4^{th}-8^{th} 8 bytes blocks of the unaligned data 270. The odd decoder 210 receives and decodes the cache memory line address to select the 1^{st}-3^{rd} 8 bytes blocks of the odd set 1 264 as the 1^{st}-3^{rd} 8 bytes blocks of the unaligned data 270. The unaligned data 270 combines the 1^{st}-3^{rd} 8 bytes blocks of the odd set 1 264 and the 4^{th}-8^{th} 8 bytes blocks of the even set 1 224 in one embodiment of the invention. The unaligned data 270 is obtained within a single read access operation in one embodiment of the invention. For clarity of illustration, the numbers indicated in the unaligned data 270 indicate the sequence of the 8 bytes blocks of the required data.

In one embodiment of the invention, the circular shift logic 240 or rotator performs a circular shift of the unaligned data 270 to obtain the aligned data 272. In one embodiment of the invention, the unaligned data 270 is shifted left by 3 bytes to obtain the correct sequence of the required data. For clarity of illustration, the numbers indicated in the aligned data 272 indicate the byte sequence of the required data.

The even block address 202 illustrate a visual map of the sets in the even set. The set 1 in the cache way 0 220 is denoted with stripes to indicate that the cache memory line address has indicated that the set 1 in cache way 0 220 has been selected. The odd block address 204 illustrates a visual map of the sets in the odd set. The set 1 in way 1 230 is denoted with stripes to indicate that the cache memory line address has indicated that the set 1 in cache way 1 220 has been selected.

The illustration in FIG. 2 is not meant to be limiting and other configurations can be used without affecting workings of the invention. For example, in one embodiment of the invention, the even decoder 205 and the odd decoder 210 are combined together. In another embodiment of the invention, the circular shift logic 240 is not part of the decoding logic and the unaligned data 270 is sent as the required data. In one embodiment of the invention, the circular shifting of the unaligned data 270 can be performed by other functional blocks in hardware or software or any combination thereof.

The configuration of the cache memory illustrated in FIG. 2 is not meant to be limiting and other configurations of the cache memory can be used without affecting the workings of the invention. For example, in one embodiment of the invention, the cache memory has more than 2 cache ways. In another embodiment of the invention, the size of the cache memory is more than 64 bytes or less than 64 bytes.

In another embodiment of the invention, the required data may span across more than two cache memory lines. To combine data from more than two cache memory lines, additional decoders are added to select the required blocks from each cache memory line. One of ordinary skill in the relevant art will readily appreciate how to combine data from more than two cache memory lines and it shall not be described herein.

FIG. 3 illustrates a format 300 of a cache memory line address in accordance with one embodiment of the invention. For clarity of illustration, FIG. 3 is discussed with reference to FIGS. 1 and 2. The cache memory line address has tag memory bits 350 field, a set index 340 field, an even/odd set 330 field, an enable boundary 320 field and a byte address 310 field in one embodiment of the invention.

In one embodiment of the invention, the tag memory bits 350 are checked against the tag directory 150 to determine if the data of a particular cache memory line address is cached in the any of the cache memories of the processing unit 105. For example, in one embodiment of the invention, the even decoder 205 and the odd decoder 210 receives the cache memory line address and compares the tag memory bits 350 with the entries in the tag directory 150 to find a match.

The even/odd set 330 field indicates whether the data of the particular cache memory is cached in an even or odd set in one embodiment of the invention. In one embodiment of the invention, the even/odd set 330 field is set to a value of 0 to indicate that the data of the particular cache memory is cached in an even set and is set to a value of 1 to indicate that the data of the particular cache memory line address is cached in an odd set.

The set index 340 field indicates the set index within each odd set or even set that is caching the data of the particular cache memory in one embodiment of the invention. For example, in one embodiment of the invention, if the tag memory bits 350 field indicate that the data of the particular cache memory line address is cached in one of the cache memory lines in the cache way 0 220, the set index 340 field indicates which one of the cache memory lines in either the even or odd set is caching the data of the particular cache memory line address.

The enable boundary 320 field indicates the boundary between where the blocks of an even set or an odd set is enabled or selected in one embodiment of the invention. For example, in one embodiment of the invention, the mask to be used for selecting the blocks of an even set is based on the enable boundary 320 field. For example, when the enable boundary 320 field is set as 010b, this indicates that the 1^{st}-2^{nd} bytes of a particular cache memory line are not selected, and the 3^{rd}-8^{th} bytes of the particular cache memory line are selected. One of ordinary skill in the relevant art will readily appreciate that the workings of the other settings of the enable boundary 320 field and shall not be described herein.

The byte address 310 field allows finer granularity between where the blocks of an even set or an odd set is enabled or selected in one embodiment of the invention. For example, when the misalignment of the data is less than a byte, the byte address 310 field is set to indicate the point between where the bits of an even set or an odd set are enabled or selected in one embodiment of the invention.

The illustration of the format 300 of the cache memory line address is not meant to be limiting and other configurations can be used without affecting the workings of the invention. For example, in one embodiment of the invention, other fields can be added to the format 300 of the cache memory line address. In another embodiment of the invention, the sequence of the fields can be arranged in a different order without affecting the workings of the invention.

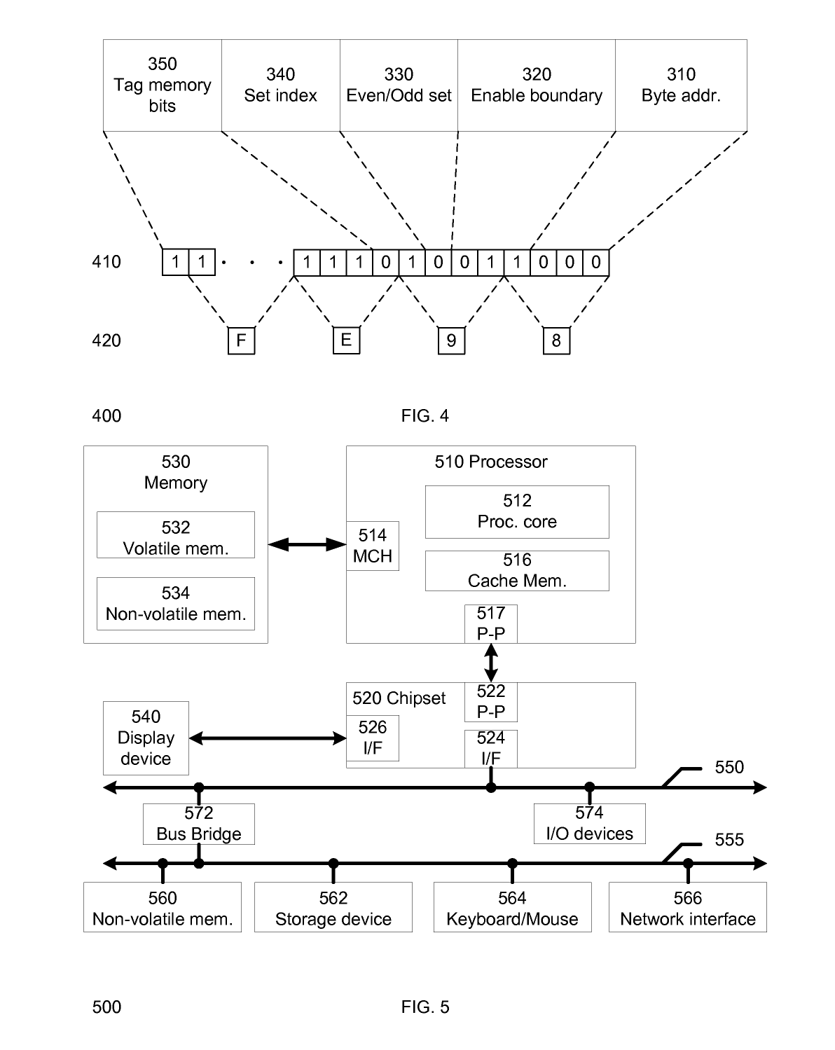

FIG. 4 illustrates an example of a cache memory line address 400 in accordance with one embodiment of the invention. For clarity of illustration, FIG. 4 is discussed with reference to FIGS. 2 and 3. For clarity of illustration, the cache memory line address 400 illustrates the cache memory line address to access the even set 1 224. The cache memory line address 400 is decoded in parallel by the even decoder 205 and the odd decoder 210 in one embodiment of the invention.

The byte address 310 field of the cache memory line address 400 is set as 000b. It is set as all zeros as the illustration in FIG. 2 allows only for byte level misalignment in one embodiment of the invention. The enable boundary 320 field of the cache memory line address 400 is set as 011b to indicate that the transition is to start from the 4^{th} byte of the cache memory line. The even/odd set 330 field is set as 0b to indicate that the cache memory line address starts on the even cache memory line.

In one embodiment of the invention, the mask to be used to obtain the selected bytes of the even set 1 224 is based on the enable boundary 320 field and the even/odd set 330 field. In one embodiment of the invention, an exclusive OR (XOR) operation of the mask generated using the enable boundary 320 field with the even/odd set 330 field is performed to obtain the mask for the even set 1 224.

For example, in FIG. 4, the enable boundary 320 field of the cache memory line address 400 is set as 011b and the initial mask is set as 00011111 by the even decoder 205. The even decoder 205 performs an XOR operation of the initial mask with the even/odd set 330 field which is set as 0b to get the final mask of 00011111 as illustrated in the even set 1 224. Each bit that is set to 1 in the final mask indicates that the respective block in the cache memory line of the even set 1 224 is selected. Each bit that is set to 0 in the final mask indicate that the respective block in the cache memory line of the even set 1 224 is not selected.

The set index 340 field of the cache memory line address 400 is set as 01b as the even set 1 224 is the second set in way 0 220. The tag memory bits 350 field is assumed to be set as all ones for clarity of illustration. The binary bits 410 illustrate the binary bit settings of the cache memory line address 400 and the settings 420 illustrate the hexadecimal values of the binary bit settings.

One of ordinary skill in the relevant art will readily how to set the cache memory line address of the odd set 1 264 and it shall not be described herein. In one embodiment of the invention, a vector load instruction with the cache memory line address of the cache memory lines to be loaded is processed by the processing unit within a single read operation. This allows the processing unit to save power consumption as it does not require more than one read operation to access more than one cache memory lines in one embodiment of the invention.

FIG. 5 illustrates a system 500 to implement the methods disclosed herein in accordance with one embodiment of the invention. The system 500 includes, but is not limited to, a desktop computer, a laptop computer, a netbook, a notebook computer, a personal digital assistant (PDA), a server, a workstation, a cellular telephone, a mobile computing device, an Internet appliance or any other type of computing device. In another embodiment, the system 500 used to implement the methods disclosed herein may be a system on a chip (SOC) system.

The processor 510 has a processing core 512 to execute instructions of the system 500. The processing core 512 includes, but is not limited to, pre-fetch logic to fetch instructions, decode logic to decode the instructions, execution logic to execute instructions and the like. The processor 510 has a cache memory 516 to cache instructions and/or data of the system 500. In another embodiment of the invention, the cache memory 516 includes, but is not limited to, level one, level two and level three, cache memory or any other configuration of the cache memory within the processor 510.

The memory control hub (MCH) 514 performs functions that enable the processor 510 to access and communicate with a memory 530 that includes a volatile memory 532 and/or a non-volatile memory 534. The volatile memory 532 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 534 includes, but is not limited to, NAND flash memory, phase change memory (PCM), read only memory (ROM), electrically erasable programmable read only memory (EEPROM), or any other type of non-volatile memory device.

The memory 530 stores information and instructions to be executed by the processor 510. The memory 530 may also stores temporary variables or other intermediate information while the processor 510 is executing instructions. The chipset 520 connects with the processor 510 via Point-to-Point (PtP) interfaces 517 and 522. The chipset 520 enables the processor 510 to connect to other modules in the system 500. In one embodiment of the invention, the interfaces 517 and 522 operate in accordance with a PtP communication protocol such as the Intel® QuickPath Interconnect (QPI) or the like. The chipset 520 connects to a display device 540 that includes, but is not limited to, liquid crystal display (LCD), cathode ray tube (CRT) display, or any other form of visual display device.

In addition, the chipset 520 connects to one or more buses 550 and 555 that interconnect the various modules 574, 560, 562, 564, and 566. Buses 550 and 555 may be interconnected together via a bus bridge 572 if there is a mismatch in bus speed or communication protocol. The chipset 520 couples with, but is not limited to, a non-volatile memory 560, a mass storage device(s) 562, a keyboard/mouse 564 and a network interface 566. The mass storage device 562 includes, but is not limited to, a solid state drive, a hard disk drive, an universal serial bus flash memory drive, or any other form of computer data storage medium. The network interface 566 is implemented using any type of well known network interface standard including, but not limited to, an Ethernet interface, a universal serial bus (USB) interface, a Peripheral Component Interconnect (PCI) Express interface, a wireless interface and/or any other suitable type of interface. The wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 5 are depicted as separate blocks within the system 500, the functions performed by some of these blocks may be integrated within a single semiconductor circuit or may be implemented using two or more separate integrated circuits. For example, although the cache memory 516 is depicted as a separate block within the processor 510, the cache memory 516 can be incorporated into the processor core 512 respectively. The system 500 may include more than one processor/processing core in another embodiment of the invention.

The methods disclosed herein can be implemented in hardware, software, firmware, or any other combination thereof. Although examples of the embodiments of the disclosed subject matter are described, one of ordinary skill in the relevant art will readily appreciate that many other methods of implementing the disclosed subject matter may alternatively be used. In the preceding description, various aspects of the disclosed subject matter have been described. For purposes of explanation, specific numbers, systems and configurations were set forth in order to provide a thorough understanding of the subject matter. However, it is apparent to one skilled in the relevant art having the benefit of this disclosure that the subject matter may be practiced without the specific details. In other instances, well-known features, components, or modules were omitted, simplified, combined, or split in order not to obscure the disclosed subject matter.

The term “is operable” used herein means that the device, system, protocol etc, is able to operate or is adapted to operate for its desired functionality when the device or system is in off-powered state. Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

The techniques shown in the figures can be implemented using code and data stored and executed on one or more computing devices such as general purpose computers or computing devices. Such computing devices store and communicate (internally and with other computing devices over a network) code and data using machine-readable media, such as machine readable storage media (e.g., magnetic disks; optical disks; random access memory; read only memory; flash memory devices; phase-change memory) and machine readable communication media (e.g., electrical, optical, acoustical or other form of propagated signals—such as carrier waves, infrared signals, digital signals, etc.).

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. An apparatus comprising:
a data cache memory having a plurality of ways; and
logic coupled with the data cache memory to facilitate access of at least two cache memory lines of the data cache memory in a single read operation.

2. The apparatus of claim 1, wherein the data cache memory has a first set of cache memory lines and a second set of cache memory lines, and wherein the logic comprises:
a first decoder associated with the first set of cache memory lines; and
a second decoder associated with the second set of cache memory lines.

3. The apparatus of claim 2, wherein the logic coupled with the data cache memory to facilitate access of the at least two cache memory lines of the data cache memory in the single read operation is to:
decode a cache memory instruction using the first and the second decoders to select one or more blocks from each of the at least two cache memory lines; and
combine the selected one or more blocks from each of the at least two cache memory lines.

4. The apparatus of claim 3, wherein the logic coupled with the data cache memory to facilitate access of the at least two cache memory lines of the data cache memory in the single read operation is further to:
perform a circular shit operation of the combined selected one or more blocks from each of the at least two cache memory lines.

5. The apparatus of claim 1, wherein the data cache memory is one of a level two (L2) cache memory, a level three (L3)cache memory.

6. An apparatus comprising:
a cache memory having a first set of cache lines comprising of cache lines with an even cache line address and a second set of cache lines comprising of cache lines with an odd cache line address;
a first decoder associated with the first set of cache lines;
a second decoder associated with the second set of cache lines; and
logic to combine one or more blocks of a cache line of the first set of cache lines with another one or more blocks of another cache line of the second set of cache lines.

7. The apparatus of claim 6, wherein the logic to combine the one or more blocks of the cache line of the first set of cache lines with the other one or more blocks of the other cache line of the second set of cache lines is performed within a single read operation.

8. The apparatus of claim 6, wherein the logic to combine the one or more blocks of the cache line of the first set of cache lines with the other one or more blocks of the other cache line of the second set of cache lines is to require a power consumption that is not greater than a power consumption of a single read operation of the cache memory.

9. The apparatus of claim 6, wherein the logic is further to:
perform a circular shift of the combined one or more blocks of the cache line of the first set of cache lines with the other one or more blocks of the other cache line of the second set of cache lines.

10. The apparatus of claim 6, wherein the first and the second decoder are to:
receive a cache memory address;
determine whether a tag address of the cache memory address matches an address of data stored in one of the first set of cache lines or stored in one of the second set of cache lines; and
determine whether a set indicator bit indicates the first set of cache lines or the second set of cache lines in response to a determination that the tag address of the cache memory address matches the address of data stored in one of the first set of cache lines or stored in one of the second set of cache lines.

11. The apparatus of claim 10, wherein the wherein the first and the second decoder are further to:
determine an set index of the first set of cache lines or the second set of cache lines in response to a determination that the set indicator bit indicates the first set of cache lines or the second set of cache lines; and
determine the one or more blocks of the cache line of the first set of cache lines or the one or more blocks of the cache line of the second set of cache lines in response to a determination of the set index of the first set of cache lines or the second set of cache lines.

12. The apparatus of claim 6, wherein the cache memory is one of a level two (L2) cache memory, a level three (L3)cache memory.

13. A method comprising:
combining one or more blocks of a cache line of a first set of cache lines with another one or more blocks of another cache line of a second set of cache lines, wherein the first set of cache lines comprises cache lines with an even cache line address, and wherein the second set of cache lines comprises cache lines with an odd cache line address.

14. The method of claim 13, wherein combining the one or more blocks of the cache memory line of the first set of cache lines with the other one or more blocks of the other cache memory line of the second set of cache lines is performed within a single read operation.

15. The method of claim 13, wherein combining the one or more blocks of the cache memory line of the first set of cache lines with the other one or more blocks of the other cache memory line of the second set of cache lines is to require a power consumption that is not greater than a power consumption of a single read operation of the cache memory.

16. The method of claim 13, further comprising:
performing a circular shift of the combined one or more blocks of the cache line of the first set of cache lines with the other one or more blocks of the other cache line of the second set of cache lines.

17. The method of claim 13, further comprising:
receiving a cache memory address;
determining whether a tag address of the cache memory address matches an address of data stored in one of the first set of cache lines or stored in one of the second set of cache lines; and
determining whether a set indicator bit indicates the first set of cache lines or the second set of cache lines in response to a determination that the tag address of the cache memory address matches the address of data stored in one of the first set of cache lines or stored in one of the second set of cache lines.

18. The method of claim 17, further comprising:
determining an set index of the first set of cache lines or the second set of cache lines in response to a determination that the set indicator bit indicates the first set of cache lines or the second set of cache lines; and
determining the one or more blocks of the cache line of the first set of cache lines or the one or more blocks of the cache line of the second set of cache lines in response to a determination of the set index of the first set of cache lines or the second set of cache lines.

19. The method of claim 13, wherein the cache memory is one of a level two (L2) cache memory, a level three (L3)cache memory.
